(19) United States
(12) Patent Application Publication
(10) Pub. No.: US 2008/0215624 A1
(43) Pub. Date: Sep. 4, 2008

(54) APPARATUS AND METHOD FOR PRODUCING PLAY LIST

(76) Inventor: Yosuke OHASHI, Saitama (JP)

Correspondence Address: BIRCH STEWART KOLASCH & BIRCH, PO BOX 747, FALLS CHURCH, VA, 22040-0747, US

(21) Appl. No.: 11/972,526

(22) Filed: Jan. 10, 2008

(30) Foreign Application Priority Data
Mar. 1, 2007 (JP) 2007-051781

(51) Int. Cl. G06F 17/00

(52) U.S. Cl. 707/104.1; 707/E17.009

(57) ABSTRACT

A play list producing apparatus retrieves words related to a query from a thesaurus database, and selects one of the related words based on the respective degrees of relevancy of the related words to the query. Music data files having such metadata that correspond to the selected related word are retrieved from a music database. The retrieved music data files are evaluated about suitability for the play list. Based on the evaluation result, a music data file is selected and registered on the play list. Then, metadata attached to the just registered music data file is served as a query for retrieving the next music data file to be registered on the play list. These processes are repeated to register music data files one after another on the play list insofar as the produced play list satisfies conditions designated by the user.

### FIELD OF THE INVENTION

The present invention relates to an apparatus and a method for producing a play list by choosing some digital contents automatically from among a variety of contents.

### BACKGROUND OF THE INVENTION

Popularization of information terminals, such as cellular phones and personal computers, makes data of huge amounts of digital contents, including video contents, audio contents, games and electronic books, available to anyone with ease these days. On the background of this trend, many kinds of techniques for providing users with useful information instantly have been suggested, for example, in JPA 2005-115727, JPA 2005-141507 and JPA 2005-348071.

JPA 2005-115727 discloses a device for managing degree of importance of association between contents and program. In this prior art, when a data file of some contents is registered in association with other contents, data of a time difference or lag from when the data file was created to when the data file is registered is attached to the data file. Then, the shorter the time difference, the higher degree of importance of association is given to the associated contents. When an end user obtains some contents, such contents that are associated with the obtained contents are also provided in order of precedence, i.e. in the order from those given the higher importance. Beside the difference between the time of creation and the time of registration, the degree of importance is raised with the amount of metadata that specify the individual content, such as genre and keywords of the contents. That is, as the number of items or the total number of bytes increases, the degree of importance goes up.

JPA 2005-141507 discloses a relevant information presenting apparatus, which extracts metadata from obtained contents. On the basis of the extracted metadata, the apparatus retrieves information relating to the obtained contents and presents it to the user. For example, where the contents provide a movie, information on casts of the movie is retrieved.

JPA 2005-348071 discloses an information processing apparatus, which retrieves such contents (information on television broadcast programs) that contain an input keyword and relevant keyword relating to the input keyword. Depending upon the degree of priority of each relevant keyword, the retrieved contents are narrowed down and presented to the user. The degree of priority of each relevant keyword is calculated based on the frequency of appearance of this keyword, which is detected by tracing records about the contents recorded, listened and reproduced by the user.

Meanwhile, portable audio players, which can record music data in a storage medium like a hard disc drive or a flash memory and reproduce the music from the recorded data, have been exploding recently. With this trend, music data supervisory software programs have been developed for taking music data out of CDs and music data distribution server, playing music, and downloading music data to the portable audio player. By installing the music data supervisory software in information processing apparatuses like user's personal computer, the user may supervise the music data comprehensively on the information processing apparatus.

The music data supervisory software is provided with a function for producing a play list of musical pieces responding to user's request from among plenty of music data files. Conventionally, producing a play list was very cumbersome because users had to input the choice of musical pieces by themselves. So many techniques have been suggested for producing a play list without bothering the user, for example, in JPA 2005-321668, JPA 2006-287379 and JPA 2006-331533.

According to a prior art disclosed in JPA 2005-321668, play list candidates of different play-back sequence are produced, and each play list candidate is evaluated about how close it is to an ideal wobble. Namely, it is determined which of the play list candidates has the closest distribution pattern of frequency components of characteristic values (tempo, mode, melody, code sequence, variety of sounds etc.) to an ideal distribution pattern that has made the user feel good. On the basis of the evaluation result, a recommendable play list is selected from among the candidates.

JPA 2006-287379 discloses a musical piece processing apparatus, wherein the user is let input additional information on each musical piece or song (genre, artist, period etc., equivalent to metadata), play history, and conditions for selection, like user's taste in music. Then the processing apparatus selects such musical pieces that meet the input conditions, and registers them on a play list.

JPA 2006-331533 discloses an automatic audio content selecting device, which recognizes user's voice performance, such as hamming, scatting, whistling and rhythm counting, and judges the degree of user's preference to respective musical pieces on the basis of the recognized vocal action, so that those musical pieces which gain higher degrees of preference are registered on a play list.

The prior art disclosed in JPA 2005-321668, however, needs producing many play lists and subjecting these play lists to frequency analysis and evaluation, which take a huge length of processing time.

In the prior art disclosed in JPA 2006-287379, the user is required to set up conditions for selection. Because musical pieces are selected according to the conditions set up by the user, the user can more or less presume what musical pieces will be listed up. So the play lists produced by this prior art tend to lack variety, and the user will be bored with it sooner or later.

Indeed the prior art disclosed in JPA 2006-331533 does not require the user any operation on the machine, but requires the vocal actions as mentioned above. Therefore, this prior art is not effective for those users who listen to the music quietly.

### SUMMARY OF THE INVENTION

In view of the foregoing, a primary object of the present invention is to provide a play list producing apparatus and a play list producing method, which make it possible to produce such a play list automatically that meets user's expectation and also arouses user's interest while the user does not need to make any cumbersome operation.

A play list producing apparatus of the present invention comprises:

a contents storage device for storing a plurality of contents, each content having metadata attached thereto;

a query entry device which a query for producing a play list is input to;

a metadata obtaining device for obtaining such metadata that relate to the input query;

a contents obtaining device for obtaining from the contents storage device those contents to which the metadata related to the input query are attached;

a selecting device for selecting a content from among those obtained by the contents obtaining device;

a registering device for registering the selected content on the play list; and

a device for feeding the query entry device with metadata of a content that has been registered on the play list as a query for another content to be registered next on the play list.

Preferably, the play list producing apparatus of the present invention further comprises a thesaurus storage device that stores data of a thesaurus that classifies and organizes words according to their mutual relations, wherein the metadata obtaining device retrieves words related to the input query from the thesaurus storage device, and the contents obtaining device obtains those contents which have metadata that include the retrieved related words.

The metadata obtaining device preferably selects one for use in the contents obtaining device from among several items of the obtained metadata, with reference to the degree of relevancy of the respective items to the obtained metadata to the query.

The contents selecting device preferably evaluates the obtained contents as to whether the obtained contents are suitable for the play list with reference to the degree of relevancy of the individual content to the query, and selects the content to be registered on the play list based on the evaluation result.

According to a preferred embodiment, the play list producing apparatus further comprising a condition entry device for inputting conditions for producing the play list, wherein the contents selecting device evaluates the obtained contents as to whether the obtained contents are suitable for the play list with reference to the input conditions, and selects the content to be registered on the play list based on the evaluation result.

Preferably, the conditions for producing the play list include an upper limit of the total number of contents to be registered on the play list, and at least one of an upper limit of the total reproduction time of the play list and an upper limit of the total data volume of the play list. The contents selecting device preferably evaluates the obtained contents based on a first expectation value that is calculated by dividing a residual reproduction time by a residual number of contents, wherein the residual reproduction time is calculated by subtracting a sum of reproduction time of the registered contents from the upper limit of the total reproduction time, and the residual number of contents is calculated by subtracting the number of registered contents from the upper limit of the total number of contents to be registered on the play list. The contents selecting device may evaluate the obtained contents based on a second expectation value that is calculated by dividing a residual recording capacity by the residual number of contents, wherein the residual recording capacity is calculated by subtracting a data volume of the registered contents from the upper limit of the total data volume of the play list.

A play list producing method of the present invention comprises steps of:

inputting a query for producing a play list;

retrieving such metadata that relate to the input query;

obtaining those contents to which the metadata related to the query are attached;

selecting a content from among the obtained contents based on preset conditions;

registering the selected content on the play list; and

inputting metadata of a content that has been registered on the play list as a query for another content to be registered next on the play list.

Since a content to be registered on a play list is selected from among those related to an input query, and metadata of the registered content is fed as a new query for retrieving another content to be registered next on the play list, the query for the next content shifts from that for the previously registered content, so a wide variety of contents are automatically registered on the play list while keeping a certain connection to each other. Thus, the user has only to make an operation for inputting an initial query, to produce a play list that meets the user's expectation.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a hardware structure of a music data supervisory system;

FIG. 2 is a block diagram illustrating an internal structure of a personal computer of the music data supervisory system;

FIG. 3 is an explanatory diagram illustrating an example of a music data index table;

FIG. 4 is an explanatory diagram illustrating an example of a metadata index table;

FIG. 5 is an explanatory diagram illustrating an example of a structure of a thesaurus;

FIG. 6 is an explanatory diagram illustrating a play list production window displayed on a monitor;

FIG. 7 is a block diagram illustrating a structure of a play list producing section;

FIG. 8 is a flowchart illustrating a sequence of processing for producing a play list;

FIG. 9 is an explanatory diagram illustrating a play list reproduction window that displays information on a related word;

FIG. 10 is an explanatory diagram illustrating another embodiment of a play list production window; and

FIG. 11 is an explanatory diagram illustrating a further embodiment of a play list production window.

### DESCRIPTION OF THE PREFERRED EMBODIMENTS

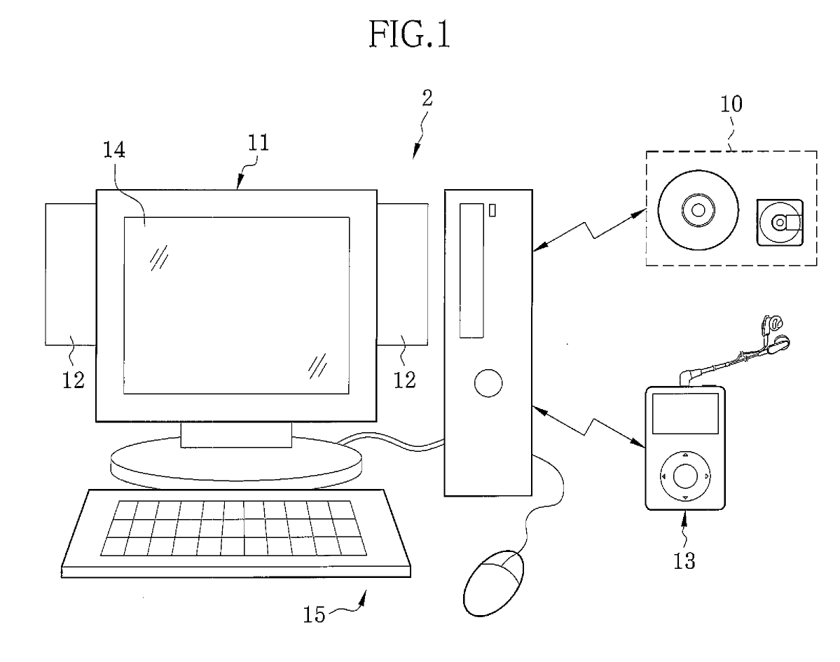

FIG. 1 shows a music data supervisory system 2, in which music data files recorded in recording media 10 like CDs and MDs are loaded into a personal computer 11, so the personal computer 11 supervises the music data files comprehensively. The personal computer 11 can reproduce musical pieces based on the loaded music data files through a speaker 12 that is attached to the personal computer 11. The music data files can also be downloaded to a portable audio player 13, hereinafter called simply the player 13 and a not-shown car audio player, so the user can listen to the musical pieces on the players. Note that the music data file and the musical piece or song contained in the music data file are used as terms with the same meaning in the present description.

For mutual data communication, the player 13 is connected to the personal computer 11 through a communication cable, e.g. an IEEE1394 type or an USB (universal serial bus) type, or a wireless LAN. The recording medium 10 can also communicate data with the personal computer 11 through a specific driver. Although it is not shown in the drawings, the personal computer 11 is connected to the Internet, so the personal computer 11 can download music data from a music data distribution server through the Internet.

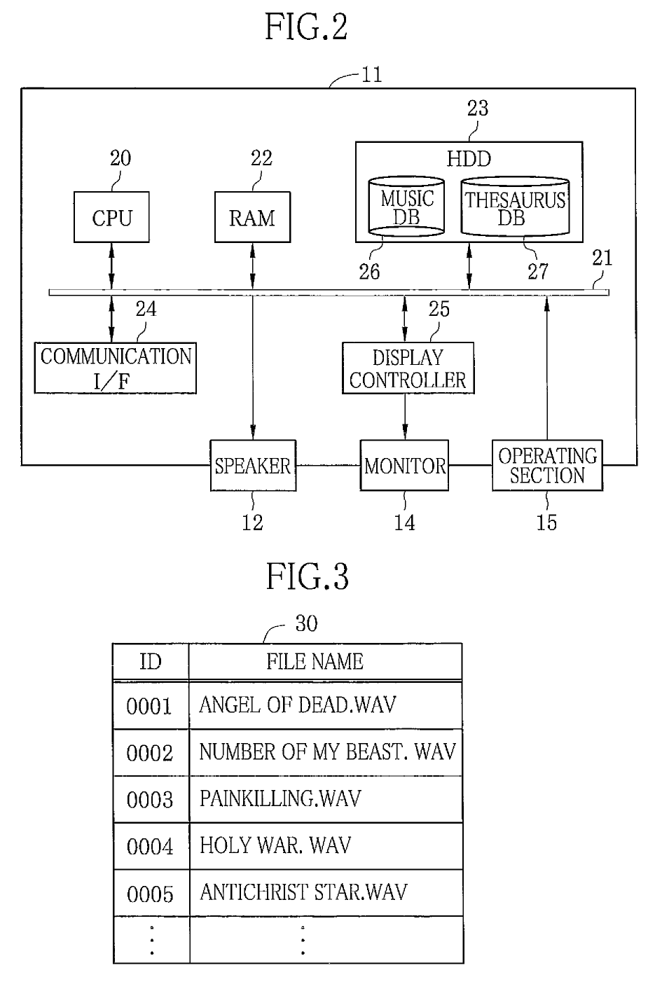

The personal computer 11 is provided with a monitor 14 and an operating section 15 consisting of a keyboard and a mouse. Referring to FIG. 2 showing the interior of the personal computer 11, a CPU 20 supervises and controls the overall operation of the personal computer 11. The CPU 20 is connected to the operating section 15, a RAM 22, a hard disc drive (HDD) 23, a communication interface (I/F) 24 and a display controller 25 through a data bus 21.

The HDD 23 stores various programs and data for operating the personal computer 11, a number of music data files read out from the recording media 10, and a music data supervisory software program for supervising the music data files. The CPU 20 reads the program out of the HDD 23 and develops it on the RAM 22 to process it sequentially. The CPU 20 controls respective components of the personal computer 11 according to operational signals input through the operating section 15.

The communication interface 24 interfaces the data communication between an external instrument like the player 13 and a communication network like the Internet. The display controller 25 controls the monitor 14 to display windows concerning the music data supervisory software and other programs.

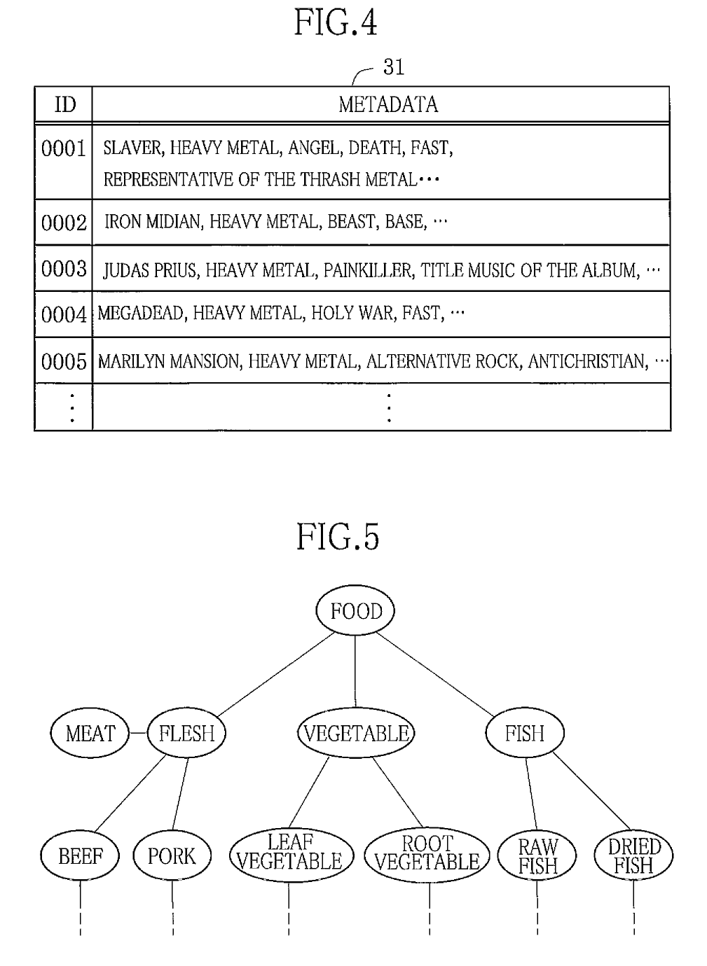

The HDD 23 is provided with a music database 26 and a thesaurus database 27. The music database 26 stores the music data files obtained from the external devices, a music data index table 30 as shown in FIG. 3 and a metadata index table 31 as shown in FIG. 4.

The music data index table 30 stores file names of the music data files stored in the music database 26, indexing with ID numbers or serial numbers that are automatically appended to the respective files as they are registered on the music data base 26. The metadata index table 31 stores metadata of the respective music data files. The same ID number is used for the metadata as the file name of the corresponding music data file.

The metadata include those originally attached to the music data file, those obtained from an external database like CDDB (compact disc database) simultaneously with downloading the music data file, those input by the user, and those automatically attached to the music data file by the personal computer 11 or the player 13. The metadata obtained from the external database may include information on an album containing the music data, such as album title, artists, the number of contained songs or musical pieces, total play time, date of release, titles of the contained songs, their play times, genre, and images of the songs. The metadata the user input may be numerical degrees of preference for the songs, comments on the songs, or words which the user associates with the title or the lyrics of the songs. The metadata attached by the personal computer 11 or the player 13 may indicate how many times the individual song has been reproduced, and the date when the song was reproduced last.

For example, the metadata attached to the music data file of ID No. 0001 include its artist name: Slaver, genre: heavy metal, words associated with the title of the contained songs: Angel and Death, and comments: a representative song of the thrash metal. The words associated with the title or the lyrics may be attached to by the personal computer 11 automatically on the basis of an analysis of the title and the lyrics. The music data index table 30 and the metadata index table 31 may be integrated into a single data table.

On the other hand, the thesaurus database 27 stores data of a Japanese thesaurus that classifies and organizes Japanese words and terms according to their mutual relations, such as their hierarchical or class relationship, part-whole relationship, and synonymous relationship, i.e. relations between words with similar meanings.

The thesaurus dictionary classifies words in a tree structure, wherein subordinate words, i.e. words with narrower meanings, are branched from a super-ordinate word, i.e. a word with a broader meaning. As shown for example in FIG. 4, “flesh”, “vegetable” and “fish” are branched from “food”. Furthermore, subordinate words to “flesh” such as “beef” and “pork” are tied to “flesh”, subordinate words to “vegetable” such as “leaf vegetable” and “root vegetable” are tied to “vegetable”, and subordinate words to “fish” such as “raw fish” and “dried fish” are tied to “fish”. Besides, “meat” is tied as a synonym to “flesh”. Although it is omitted from the drawing, related words are further tied to the respective subordinate words such as “beef” and “pork”.

To obtain music data files, the user operates the operating section 15 to start up the music data supervisory software program. The music data supervisory software is provided with a mode for obtaining music data files, and a mode for producing a play list, which selects appropriate musical pieces to reproduce from among the music data files stored in the music database 26.

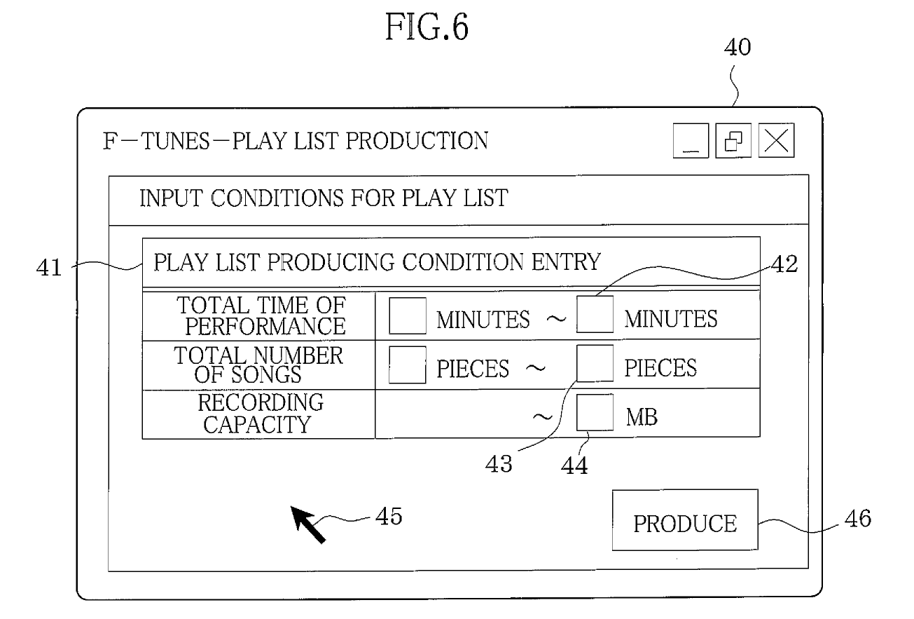

As the play list production mode is selected, a play list production window 40 is displayed on the monitor 14, as shown in FIG. 6. The play list production window 40 is provided with a play list producing condition entry zone 41 for inputting conditions for producing a play list.

In the play list producing condition entry zone 41, there are provided entry bars 42, 43 and 44 for inputting upper and lower limits of the total performance time of the play list, upper and lower limits of the total number of musical pieces or songs on the play list, and an upper limit to the total data volume of the play list. The user can input the limit values by clicking a pointer 45 on each entry bar 42, 43 or 44 through the mouse of the operating section 15 and then entering a number through the keyboard. The user does not need to input the lower limits to the total play time and the total play number, but need to input the respective upper limits. The entry bars 42 to 44 may be pull-down menu bars, which display a number scale as a pull-down selection menu upon the user clicking thereon, so that the user may select a number as the limit value on the scale. Furthermore, the unit of the total play time and the unit of the data volume, i.e. “minute” and “MB (megabyte)” in FIG. 6, may be made changeable by use of pull-down selection menus.

A production button 46 is provided below the play list producing condition entry zone 41. Upon clicking the pointer 45 on the production button 46, the metadata of a musical piece being played back presently, which corresponds to a query, and information on the play list producing conditions which are presently input in the play list producing condition entry zone 41 are output to the RAM 22. If the user clicks on the production button 46 before inputting all the upper limits in the entry bars 42 to 44, the user is warned of the need to input the upper limits, for example, by displaying a warning message.

In the description of the embodiment, it is assumed that a musical piece or song chosen by the user through the operating section 15 is being reproduced before the user clicks the production button 46, and a play list is produced based on the presently reproduced song.

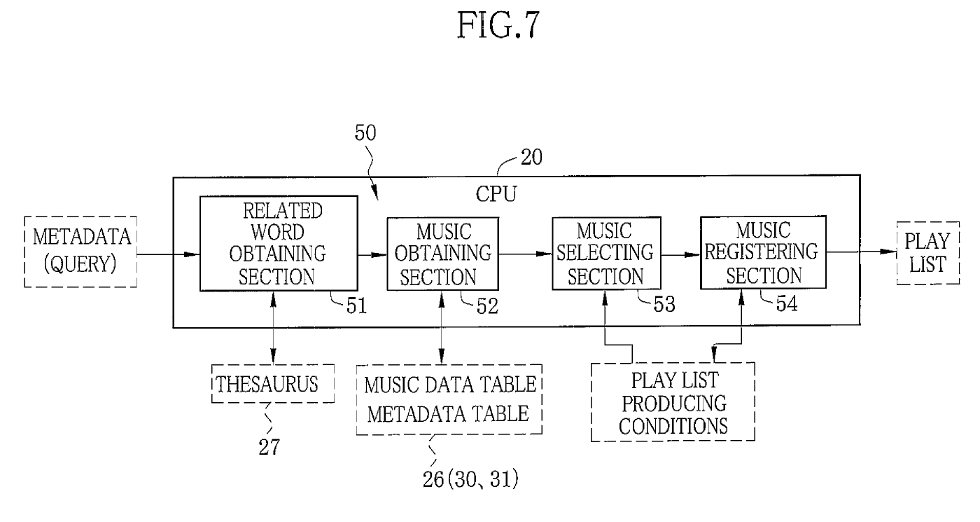

In the play list production mode, a play list producing section 50 is built up in the CPU 20, as shown in FIG. 7. The play list producing section 50 consists of a related word obtaining section 51, a music obtaining section 52, a music selecting section 53, and a music registering section 54.

The related word obtaining section 51 reads metadata of the song which is being reproduced when the produce button 46 is actuated. Then the related word obtaining section 51 accesses to the thesaurus database 27, searching the thesaurus database 27 for words related to the metadata. As for the example of FIG. 5, if the keyword is “food”, all the subordinate words which are branched from the word “food”, including “flesh”, “meat” and “beef”, are retrieved as the related words. Note that the number of items of the metadata for obtaining related words may be single or plural.

On retrieving the related words, the related word obtaining section 51 scores the degree of relevancy of each related word to the metadata, for example, by converting the distance in meaning between the metadata and the related word to a numerical value. Concretely, a keyword contained in the metadata is assumed to have a perfect score, e.g. 100 points, and its related words are scored in mark-back system: a synonym is −1 point, a broader term and a narrower word are −2 points, and an antonym is −3 points. A narrower term subordinate to a synonym to the keyword is (−1)+(−2)=−3 points, and a term still narrower than a narrower word to the keyword is (−2)+(−2)=−4 points. Referring again to the example of FIG. 5, if the keyword is “food”, the score of its subordinate word “flesh” is 100−2=98. The word “beef” that is subordinate to the word “flesh” gets a score of 96 (=100−2−2). The score of “meat”, a synonym to “flesh”, is 97 (=100−2−1).

The related word obtaining section 51 chooses a predetermined number of related words in the order from one getting the highest score or related words of higher scores than a predetermined threshold value, and outputs information on the chosen related words and information on the scores of these related words to the RAM 22.

The information on the related words as chosen by the related word obtaining section 51 is read out from the RAM 22 to the music obtaining section 52, to retrieve those music data files from the music database 26, which the chosen related words are attached to as metadata. Concretely, the music obtaining section 52 searches the metadata index table 31 for such metadata that correspond to at least part of the chosen related words, and obtains the ID numbers of these metadata. Then, the music obtaining section 52 retrieves those music data file names indexed with the obtained ID numbers from the music data index table 30, and obtains the music data files of the retrieved file names from the music database 26. The music data files 22 obtained by the music obtaining section 52 is written in the RAM 22. As the formula of retrieving the metadata, AND-retrieval and/or OR-retrieval and/or NOT-retrieval maybe adopted. Alternatively, the user can designate the retrieval formula.

The music selecting section 53 reads the music data files out of the RAM 22, and selects a musical piece to be registered on the play list from among the read music data files. The music selecting section 53 also provides each music data file with an evaluation value that shows the degree of suitability of the musical piece for the play list. For example, the scores served to select the related words by the related word obtaining section 51 may be served as the evaluation values.

Instead of or in addition to the score indicating the degree of relevancy to a keyword, the evaluation value may be determined in the manner as set forth below.

The music selecting section 53 reads the play list producing conditions, which the user input on the play list production window 40 through the operating section 15, out of the RAM 22. Then, the music selecting section 53 calculates expectation values T1 and T2:

T1=residual performance time/residual number of songs (1)

T2=residual recording capacity/residual number of songs (2)

Note that the residual performance time is a length of time available for songs added to the play list from now on without going over the upper limit of the total performance time of the play list, whereas the residual number of songs is the number of songs capable of being added to the play list from now on within the upper limit of the total number of songs, and the residual recording capacity is a data volume remaining for the songs to be registered on the play list within the upper limit. Data of the residual performance time, the residual recording capacity and the residual number of songs are written in the RAM 22 by the music registering section 54, as set forth later.

The expectation values T1 and T2 represent such performance time and recording capacity respectively that are expected to be allocated to one song as it is registered on the play list, for the sake of producing the play list to meet the producing conditions. For example, when the residual number of songs is three, whereas the residual performance time is 9 minutes, the expectation value T1 is 3 minutes according to the equation (1). That is, if the song to be registered next takes a performance time of 3 minutes and remaining two songs take a performance time of 6 minutes or less in total, it is possible to produce the play list according to the designated conditions.

The music selecting section 53 calculates a difference between the performance time of a song and the expectation value T1, as well as a difference between the requisite recording capacity of the song and the expectation value T2, to evaluate the song according to the calculated differences. For example, a maximum evaluation value “100” is given to a song, of which the differences from the expectation values T1 and T2 are “0”. As these differences become the larger, the evaluation value is marked back the more from the maximum value. In a case where the differences calculated from the expectation values T1 and T2 are used in combination with the score calculated by the related word obtaining section 51, the score is reduced by an amount corresponding to the differences.

The music selecting section 53 selects the song with the highest evaluation value to be registered on the play list. Thereafter, the music selecting section 53 checks whether the play list after having the selected song registered thereon goes over the upper limits of the play list producing conditions. If not, the music selecting section 53 outputs the music data file of the song with the highest evaluation value to the RAM 22.

If, on the contrary, the song with the highest evaluation value will make the play list go over the upper limits of the play list producing conditions, the music selecting section 53 retry to select another song that fits the play list producing conditions from among the songs obtained by the music obtaining section 52, taking their evaluation values into account. That is, the music selecting section 53 puts the songs obtained by the music obtaining section 52 into the play list one by one in the order from one with the higher evaluation value, and checks whether the individual song satisfies the play list producing conditions. Thus, the song judged to meet the conditions is finally selected to be registered, and the music selecting section 53 outputs the music data file of the selected song to the RAM 22. If there are not any songs that meet the play list producing conditions among the songs obtained by the music obtaining section 52, the music selecting section 53 supplies the music registering section 54 with a signal notifying that there remain no song to register.

The music registering section 54 reads the music data file of the song selected by the music selecting section 53 out of the RAM 22, and registers it on the play list. Simultaneously, the music registering section 54 reads the play list producing conditions out of the RAM 22, and calculates the latest values of the residual performance time and the residual recording capacity by subtracting a sum of the performance time of the registered songs, including the just registered one, from the upper limit of the total performance time of the play list, as well as by subtracting a sum of data volume of the registered songs, including the just registered one, from the upper limit of the total data volume of the play list. Thus, the data of the residual performance time and the data of the residual recording capacity are rewritten with the latest values in the RAM 22. The music registering section 54 also rewrites data of the residual number of songs to decrement it on the RAM 22. If the music selecting section 53 outputs the signal notifying that there are not any songs capable of being registered on the play list, the music registering section 54 outputs data of the registered songs as the produced play list to the RAM 22.

Note that the evaluation based on the expectation values T1 and T2 is preferably executed only in the last stage of producing the play list, that is, first when the residual number of songs capable of being registered on the play list becomes two or three. This is because in the first stage of producing the play list, there is little risk of going over the upper limits of the play list producing conditions even if such songs are registered that do not strictly meet the play list producing conditions.

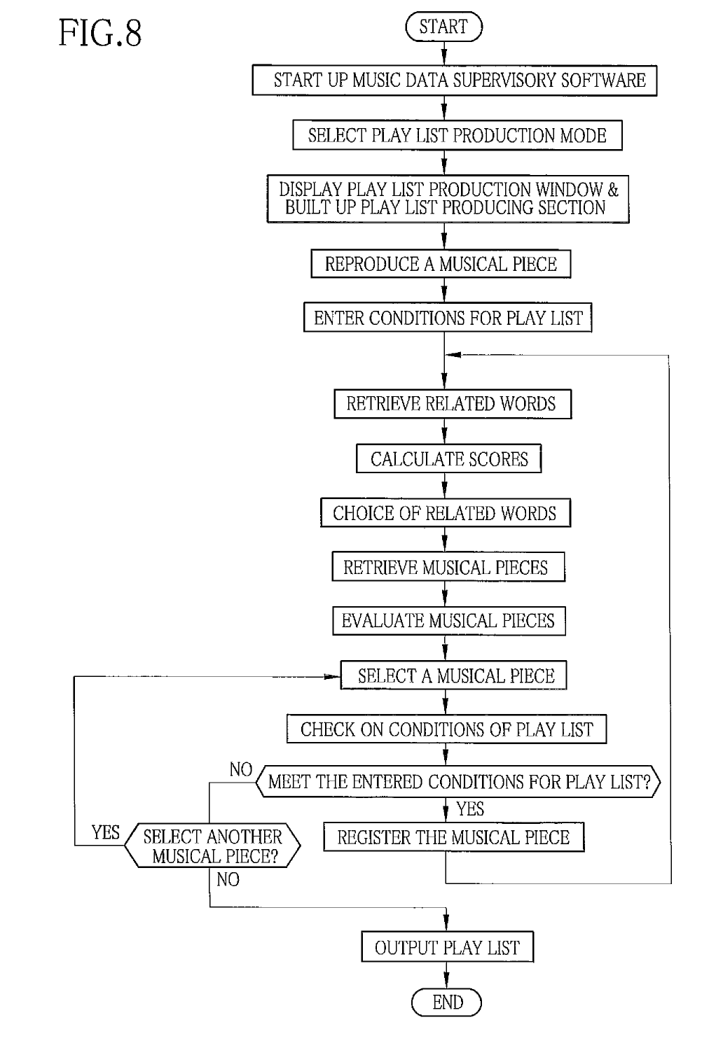

Next, the sequence of processing in the music data supervisory system 2 will be described with reference to the flow chart of FIG. 8. First, the music data supervisory software program is started up, and when the play list production mode is selected, the play list production window 40 is displayed on the monitor 14. Simultaneously, the play list producing section 50 is built up in the CPU 20.

The user inputs desirable conditions for producing a play list on the play list production window 40 by operating the operating section 15, and clicks on the production button 46 to complete the condition inputting process. Upon the production button 46 being clicked, metadata of a song that is being reproduced at that time and data of the input play list producing conditions are written in the RAM 22. Note that the play list production mode may be selected after starting reproducing a song, or the play list producing conditions may be input before starting reproducing a song, reversely to the sequence illustrated in FIG. 8.

The metadata of the song, which was being reproduced at the time when the production button 46 was selected, is read out from the RAM 22 to the related word obtaining section 51. The related word obtaining section 51 retrieves words related to the metadata from the thesaurus database 27, and obtains respective scores of the retrieved related words. Thereafter, the related word obtaining section 51 chooses a predetermined number of related words in the order from one getting the highest score or related words of higher scores than a predetermined threshold value, and outputs information on the chosen related words and information on the scores of these related words to the RAM 22.

The information on the related words as chosen by the related word obtaining section 51 is read out from the RAM 22 to the music obtaining section 52. The music obtaining section 52 retrieves those music data files from the music database 26, which the chosen related words are attached to as their metadata, referring to the music data index table 30 and the metadata index table 31. The music data files obtained by the music obtaining section 52 are written in the RAM 22.

The music data files obtained by the music obtaining section 52 are read out from the RAM 22 to the music selecting section 53. The music selecting section 53 evaluates the music data files on the basis of the scores of the related words and the expectation values T1 and T2, and selects the song with the highest evaluation value.

The music selecting section 53 checks whether the play list after having the selected song registered thereon goes over the upper limits of the producing conditions. If not, the music data file of the song with the highest evaluation value is sent through the RAM 22 to the music registering section 54, to be registered on the play list.

If, on the contrary, the song with the highest evaluation value will make the play list go over the upper limits of the play list producing conditions, the music selecting section 53 selects other songs obtained by the music obtaining section 52 seriatim from one with the higher evaluation value, and checks whether the individual song satisfies the play list producing conditions. Thus, another song satisfying the conditions is selected to be registered, and the music data file of the selected song is output to the RAM 22.

The music registering section 54 reads the music data file of the song selected by the music selecting section 53 out of the RAM 22, and registers it on the play list. Simultaneously, the music registering section 54 revises the residual performance time, the residual recording capacity and the residual number of songs, by rewriting the data of these values on the RAM 22.

When the music selecting section 53 determines that there are not any songs that meet the play list producing conditions among the songs obtained by the music obtaining section 52, the music selecting section 53 output supplies the music registering section 54 with the signal notifying that there are not any songs to register. Then the data of the play list produced by the music registering section is output to the RAM 22.

Each time a song is registered on the play list by the music registering section 54, the metadata of the registered song is read out from the RAM 22 to the related word obtaining section 51. Then the related word obtaining section 51 retrieves related word, using the metadata of the just registered song as a new query. That is, the metadata of the preceding song on the play list is used as the query for the next song to be registered. Thus, the play list producing section 50 carries out the above-described processes, i.e. retrieving related words, retrieving music data files, selecting a song, and registering the song, cyclically till it completes the play list fulfilling the producing conditions.

The output data of the complete play list from the music registering section 54 may be displayed as a production result on the monitor 14. Also, in response to the operations on the operating section 15, the play list is reproduced, stored in the HDD 23, or downloaded to the player 13. While the play list is being reproduced, the registered songs are played back in the same sequence as they are registered.

As described so far, songs or musical pieces are retrieved based on related words to a query, and a song is selected to be registered on a play list from among the retrieved songs. Then, metadata of the just registered song is used for a query for retrieving a song to be registered next. Therefore, the produced play list gains a great variety while keeping connection of one song to the next song. For example, if an initial query is a year in which a music album is released, the next song selected to be registered is not limited to one released in the same year. Thus, the user or listener cannot presume the next song, so the listener will not be bored with the play list. The user has only to do some operations for playing back a musical piece and inputting conditions for producing the play list, and does not need to make any special performance like the voice performance as mentioned above in the description of the prior arts.

Although the selection of songs is based on the evaluation values in the above embodiment, it is possible to select the songs regardless of the evaluation values. In that case, the music selecting section 53 may select a song regardless of its evaluation value at a predetermined timing, such as at intervals of a predetermined number of songs, or when the residual number of songs capable of being registered comes to a predetermined number. The music selecting section 53 may also select a song regardless of its evaluation value at an arbitrary timing. The song selected regardless of its evaluation value may be from among the songs obtained by the music obtaining section 52, or it is possible to select the song at random from the music database 26. Adding such songs will give unpredictable variations to the play list, which is apt to become monotonous if it is composed of songs with high evaluation values only. Such variations will stimulate the user's interest in the play list more. After selecting a song regardless of its evaluation value, metadata of this song or metadata of the song registered before this song may be used as a query for the next song.

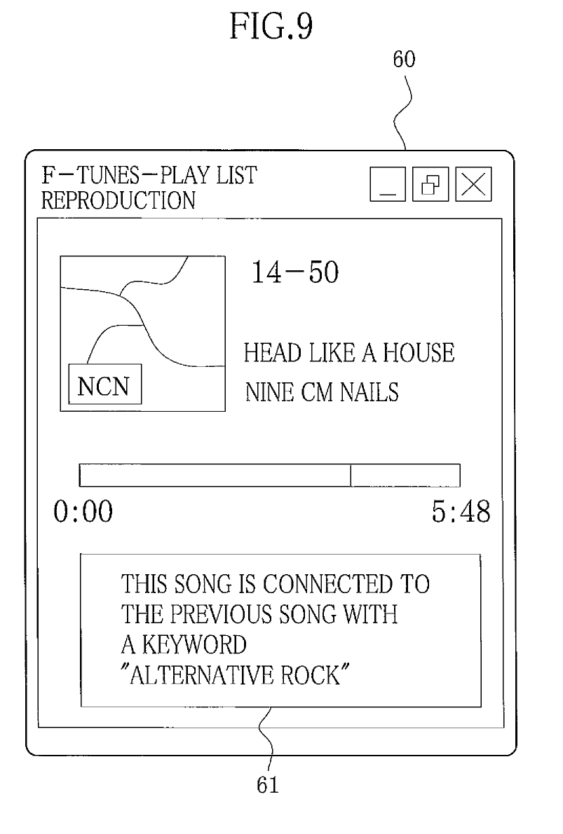

Meanwhile, the user may feel strange about some of the songs on the play list, without knowing how and why these songs have been registered on the play list. To make up for this inadequacy, it is possible to memorize information on related words as used for retrieving a song along with the data of the song when it is registered on the play list, and display the information on the related words, as shown for example in a relevancy information display zone 61 of a play list reproduction window 60 in FIG. 9. The play list reproduction window 60 also shows the title and artist of the song as being played back at present, the art work of the album of this song, and a bar indicating the elapse of the performance time. The relevancy information may be a message, like in FIG. 9, or just the related words. Beside the related words, numbers indicating the degree of relevancy of the related words, like the scores and the evaluation values in the above embodiment, may be displayed. In a case where the play list contains a song selected regardless of its evaluation value, information on that fact may be displayed. Thus, the user can see how the songs have concretely been registered on the play list, so the convenience of the user is still more improved.

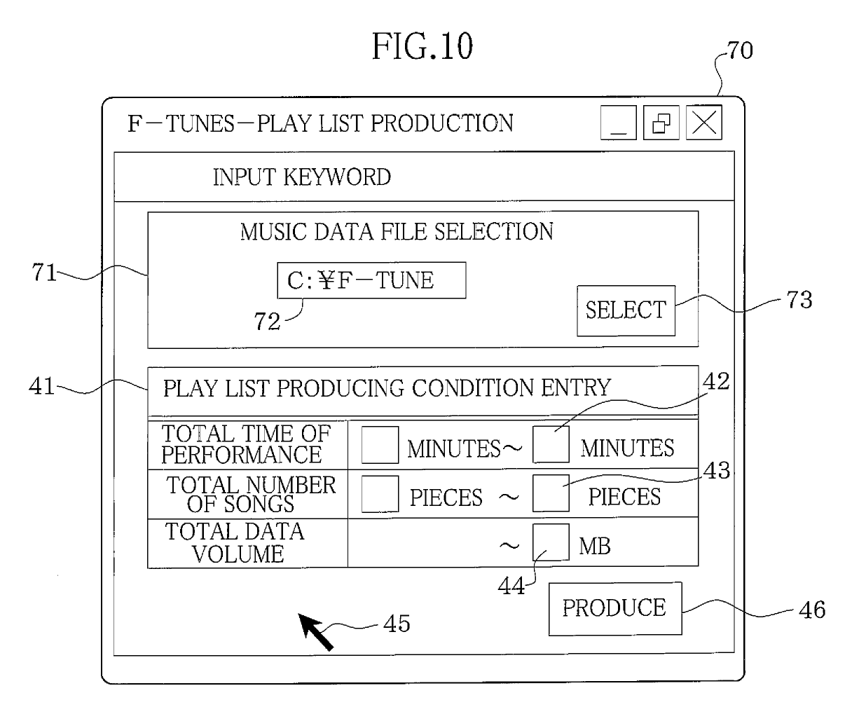

The query for starting producing a play list is not limited to the metadata of the presently reproduced musical piece. In place of or in addition to the metadata of the presently reproduced musical piece, the query may be metadata of a musical piece that is selected by the user through the operating section 15. In that case, as shown for example in FIG. 10, a play list production window 70 is provided with an entry zone 71 for selecting a musical piece beside a play list producing condition entry zone 41.

The entry zone 71 is provided with a file dialog 72 that displays a pass to a memory location of the HDD 23 in which a music data file is stored, and a select button 73 for selecting the music data file. Upon clicking the mouse while putting the pointer 45 on the select button 73, the file dialog 72 is developed and a list of icons of music data files and folders as stored in the HDD 23 is displayed in a hierarchical structure. The user can select one of the music data files by clicking the pointer 45 on its icon. Although the embodiment shown in FIG. 10 is designed to select a music data file, it is possible to select more than one music data file from among those stored in the HDD 23.

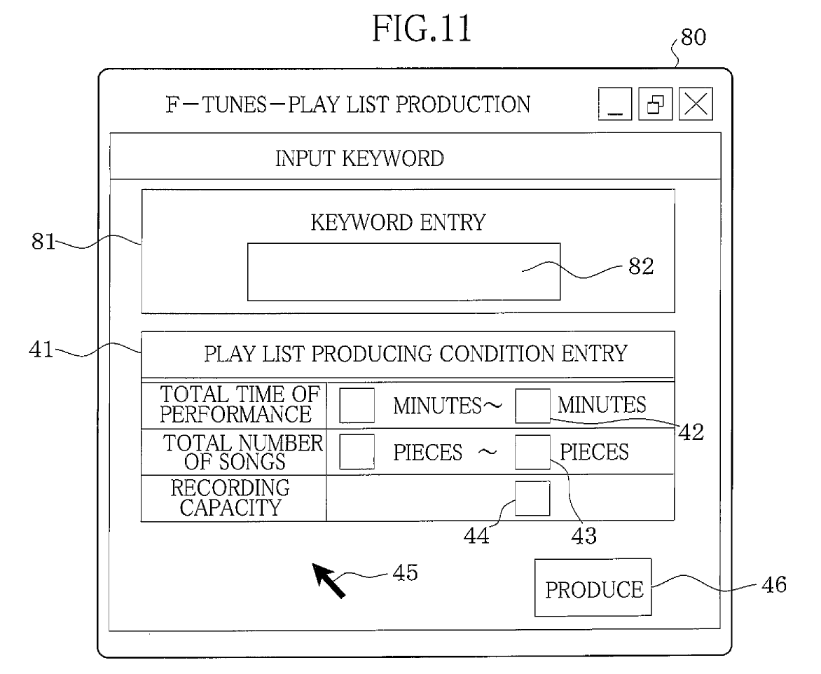

It is also possible that the user inputs a letter string or keyword as the query. In that case, as shown in FIG. 11, an entry zone 81 for inputting a keyword is provided above a play list producing condition entry zone 41.

The entry zone 81 is provided with an entry bar 82 for inputting a letter string as a keyword. The user can input a letter string through the keyword after clicking the pointer 45 on the entry bar 82. Although three variations of how to get the query for starting producing a play list has been described as individual embodiments with reference to FIGS. 6, 10 and 11, it is possible to provide the entry zones 71 and 81 in the play list production window 40, so that the user may choose from among the three variations.

Note that the structure of the thesaurus database, the methods of selecting related words and musical pieces for a play list, and the layouts of the respective windows are not to be limited to the above embodiments. Also, the method of scoring the degree of relevancy of each related word to the keyword is not to be limited to the above-mentioned mark-back system, but another method is usable. For example, it is possible to register scores of the respective words previously in the thesaurus database 27. It is also possible to weight the scores according to the words, so that a word which is distant in the meaning from a keyword but is tightly associated with the keyword, e.g. “top of Japan” to “Mt. Fuji”, will get a high score. The method of evaluating suitability of each musical piece for a play list can also be modified appropriately.

In the above-described embodiment, the play list producing section 50 is built in the CPU 20 when the user selects the play list production mode. But it is possible to mount the play list producing section 50 as hardware components, e.g. in the form of discrete circuits or FPGA (field programmable gate array), in the personal computer 11. It is also possible to construct the play list producing section 50 as a separate device that is connectable to the personal computer 11. Furthermore, the music database 26 and the thesaurus database 27 may be installed in an external device like a music data distribution server.

Although the above-described embodiment refers to musical pieces as the contents to be retrieved, the present invention is applicable not only to audio contents but also to video contents, i.e. movies, pictures, games, electronic books and the like. Where the contents are movies or pictures, the present invention is to produce a play list consisting of video clips or digest versions of the movies or a play list consisting of slide-shows of the pictures. According to the applied contents, items to enter as conditions for producing the play list may be modified appropriately. For example, a playback time for each video clip may be entered as a condition.

Thus, the present invention is not to be limited to the above-described embodiments but, on the contrary, various modifications will be possible without departing from the scope of claims appended hereto.

What is claimed is:

1. A play list producing apparatus comprising:
a contents storage device for storing a plurality of contents, each content having metadata attached thereto;
a query entry device which a query for producing a play list is input to;
a metadata obtaining device for obtaining such metadata that relate to the input query;
a contents obtaining device for obtaining from said contents storage device those contents to which the metadata related to the input query are attached;
a selecting device for selecting a content from among those obtained by said contents obtaining device;
a registering device for registering the selected content on the play list; and
a device for feeding said query entry device with metadata of a content that has been registered on the play list as a query for another content to be registered next on the play list.

2. A play list producing apparatus as recited in claim 1, further comprising a thesaurus storage device that stores data of a thesaurus that classifies and organizes words according to their mutual relations, wherein said metadata obtaining device retrieves words related to the input query from said thesaurus storage device, and said contents obtaining device obtains those contents which have metadata that include the retrieved related words.

3. A play list producing apparatus as recited in claim 1, wherein said metadata obtaining device selects one for use in said contents obtaining device from among several items of the obtained metadata, with reference to the degree of relevancy of the respective items to the obtained metadata to the query.

4. A play list producing apparatus as recited in claim 1, wherein said contents selecting device evaluates the obtained contents as to whether the obtained contents are suitable for the play list with reference to the degree of relevancy of the individual content to the query, and selects the content to be registered on the play list based on the evaluation result.

5. A play list producing apparatus as recited in claim 1, further comprising a condition entry device for inputting conditions for producing the play list, wherein said contents selecting device evaluates the obtained contents as to whether the obtained contents are suitable for the play list with reference to the input conditions, and selects the content to be registered on the play list based on the evaluation result.

6. A play list producing apparatus as recited in claim 5, wherein said conditions include an upper limit of the total number of contents to be registered on the play list, and at least one of an upper limit of the total reproduction time of the play list and an upper limit of the total data volume of the play list.

7. A play list producing apparatus as recited in claim 6, wherein said contents selecting device evaluates the obtained contents based on a first expectation value that is calculated by dividing a residual reproduction time by a residual number of contents, wherein said residual reproduction time is calculated by subtracting a sum of reproduction time of the registered contents from the upper limit of the total reproduction time, and said residual number of contents is calculated by subtracting the number of registered contents from the upper limit of the total number of contents to be registered on the play list.

8. A play list producing apparatus as recited in claim 6, wherein said contents selecting device evaluates the obtained contents based on a second expectation value that is calculated by dividing a residual recording capacity by a residual number of contents, wherein said residual recording capacity is calculated by subtracting a data volume of the registered contents from the upper limit of the total data volume of the play list, and said residual number of contents is calculated by subtracting the number of registered contents from the upper limit of the total number of contents to be registered on the play list.

9. A play list producing apparatus as recited in claim 1, wherein said contents selecting device selects such a content that is less related to the query at predetermined or arbitrary timing than normally selected contents.

10. A play list producing apparatus as recited in claim 1, further comprising a relevancy information storage device for storing information on relevancy between the selected contents and the metadata used for retrieving these contents, and a display device for displaying the relevancy information.

11. A play list producing apparatus as recited in claim 1, wherein as an initial query for starting producing a play list, said query entry device is fed with at least one of metadata of a presently reproduced content, metadata of a content chosen by a user, and a letter string input by a user.

12. A play list producing apparatus as recited in claim 1, wherein said contents are music data.

13. A play list producing apparatus as recited in claim 1, wherein said contents are video data.

14. A play list producing method comprising steps of:
inputting a query for producing a play list;
retrieving such metadata that relate to the input query;
obtaining those contents to which the metadata related to the query are attached;
selecting a content from among the obtained contents based on preset conditions;
registering the selected content on the play list; and
inputting metadata of a content that has been registered on the play list as a query for another content to be registered next on the play list.

15. A play list producing method as recited in claim 14, further comprising a step of retrieving words related to the input query from a thesaurus that that classifies and organizes words according to their mutual relations, wherein those contents which have metadata that include the retrieved related words are obtained from a storage device.
